(19) United States
(12) Patent Application Publication
(10) Pub. No.: US 2002/0036672 A1
(43) Pub. Date: Mar. 28, 2002

(54) Ink jet printer having a printhead and a method of removing air bubbles

(75) Inventors: Thomas P. Courtney, Fairport, NY (US); Jacques Webster-Curley, Perry, NY (US); Andrew W. Hays, Fairport, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/000,970

(22) Filed: Oct. 24, 2001

Related U.S. Application Data
(63) Continuation-in-part of application No. 09/467,479, filed on Dec. 20, 1999.

(30) Foreign Application Priority Data
Jul. 12, 2000 (EP) 003108651
Dec. 12, 2000 (JP) 2000376850

(51) Int. Cl. B41J 2/165

(52) U.S. Cl. 347/30

(57) ABSTRACT

A simultaneous push-pull method of, and apparatus for, removing air bubbles from a powerable ink jet printhead are provided. The printhead includes a printhead die containing liquid ink and heating elements within ink channels, and has a nozzle face and nozzles connected to the ink channels. The simultaneous push-pull method includes providing a printhead capping member including side walls, a bottom wall, a vacuuming path through the bottom wall, and a capping recess defined by the side walls and the bottom wall. The method then includes applying heat energy to the heating elements to reduce a viscosity of ink in the channels, activating a print mode of the printhead, firing the printhead while in the print mode to eject droplets of liquid ink in an ink ejecting direction through nozzles into the capping recess. The method also includes simultaneously applying a vacuum force through the capping recess to the nozzle face for additively pulling and moving ink in the ink channels through the nozzles and in the ink ejecting direction, thereby effectively priming the nozzles by reducing viscosity of ink in the channels and removing such ink and undesirable air bubbles from the ink channels.

### RELATED APPLICATION

This application is a continuation in part of U.S. application Ser. No. 09/467,479 (Applicants' Docket No. D/99758) entitled “INK JET PRINTER INCLUDING A PRINTHEAD AND A METHOD OF REMOVING BUBBLES FROM INK JET PRINTHEADS” filed on Dec. 20, 1999, and having common inventors.

### BACKGROUND OF THE INVENTION

The present invention relates generally to ink jet printers including printheads and, more particularly, to such a printer including a method of effectively removing air bubbles from such printhead during periodic maintenance of the printhead.

An ink jet printer of the so-called “drop-on-demand” type has at least one printhead from which droplets of ink are directed towards a recording medium. Within the printhead, the ink may be contained in a plurality of channels and energy pulses are used to cause the droplets of ink to be expelled, as required, from orifices at the ends of the channels.

In a thermal ink jet printer, the energy pulses are usually produced by resistors, each located in a respective one of the channels, which are individually addressable by current pulses to heat and vaporize ink in the channels. As a vapor bubble grows in any one of the channels, ink bulges from the channel orifice or nozzle until the current pulse has ceased and the bubble begins to collapse. At that stage, the ink within the channel retracts and separates from the bulging ink which forms a droplet moving in a direction away from the channel and towards a recording medium. The channel is then refilled by capillary action, drawing ink from a supply container.

Examples of thermal ink jet printers are described in U.S. Pat. No. 4,638,337 and U.S. Pat. No. 5,896,144. Such printers are the carriage type and each has a plurality of printheads, each with its own ink supply cartridge, mounted on a reciprocating carriage. The channel orifices or nozzles in each printhead are aligned perpendicular to the line of movement of the carriage and a swath of information is printed on the stationary recording medium as the carriage is moved in one direction. The recording medium is then stepped, perpendicular to the line of carriage movement, by a distance equal to the width of the printed swath and the carriage is then moved in the reverse direction to print another swath of information.

It has been recognized that there is a need to maintain the ink ejecting orifices of an ink jet printer, for example, by periodically cleaning the orifices when the printer is in use, and/or by capping the printhead when the printer is out of use or is idle for extended periods. The capping of the printhead is intended to prevent the ink in the printhead from drying out. There is also a need to prime a printhead before use, to ensure that the printhead channels are completely filled with ink and contain no contaminants or bubbles. Maintenance and/or priming stations for the printheads of various types of ink jet printers are described in, for example, U.S. Pat. No. 4,863,717 and the removal of gas from the ink reservoir of a printhead during printing is described in U.S. Pat. No. 4,679,059 and illustrated in JP10138515. All of these patents are hereby incorporated by reference.

Bubbles in different locations of the ink path that feeds the thermal ink jet printhead can range from harmless to very problematic. Removing these bubbles can be very difficult and requires the removal of large amounts of ink in order to “pull” the air bubble out as is the case for example in JP10138515. The problem is that bubbles are difficult to break up and pull through the small nozzles of the printhead, and this problem is made worse by the viscosity of the ink.

Air bubbles in the print head, especially those near the nozzles can and do restrict fluid flow to the nozzles. This is especially apparent when printing high area coverage regions at high frequency, and at elevated temperatures. The air bubble will cause 2-8 adjacent nozzles or jets to intermittently misfire, causing highly noticeable horizontal white streaks across the image. It has been found that the size of the air bubble relative to the printhead or die reservoir volume directly influences the nature of the print quality defect. Small bubbles will not cause any problems. Medium bubbles may cause 1 or 2 jets to misfire. Large bubbles may cause a large bank of jets to poorly fire.

Conventional methods for removing air bubbles involve applying a vacuum force to the print head for extracting ink and air from the printhead through the apertures or openings of the nozzles, and/or applying pumping pressure to the ink supply line. However, as the resolution of inkjet devices increases, the apertures of the nozzles are becoming significantly smaller and smaller, thereby limiting the ability of ink to flow during such a vacuum operation. For example, it has been found that when conventionally applying a vacuum pressure of about 300 mmHg to the front face or nozzle face of a printhead, large problem bubbles are difficult to remove.

### SUMMARY OF THE INVENTION

In accordance with the present invention, there is provided a simultaneous push-pull method of removing air bubbles from the nozzles of a powerable ink jet printhead. The method includes the steps of providing a printhead capping member including side walls, a bottom wall, a vacuuming path through said bottom wall, and a capping recess defined by the side walls and the bottom wall; applying heat energy to the printhead die to reduce a viscosity of in the channels of the printhead; activating the print mode of the printhead; firing the printhead nozzles while in the print mode to eject drops of liquid ink in an ink ejecting direction through nozzles in the nozzle face and into the capping recess; and simultaneously applying a vacuum force through the capping recess to the nozzle face for additively pulling and moving ink in the ink channels through the nozzles and in the ink ejecting direction, thereby effectively priming the nozzles in the nozzle face by removing ink and undesirable air bubbles from the ink channels within the printhead.

### BRIEF DESCRIPTION OF THE DRAWINGS

In the detail description of the invention presented below, reference is made to the drawings, in which:

FIG. 1 is a schematic elevational view of a liquid ink printer including a controller and a powerable printhead for application of the method of the present invention;

FIG. 2 is a schematic illustration of an ink jet printhead die showing the heater plate and channel heating resistors; and

FIG. 3 is a schematic illustration of a capping member in sealing engagement with the nozzle face of the powerable ink jet printhead for application of the method of the present invention.

### DESCRIPTION OF THE INVENTION

While the present invention will be described in connection with a preferred embodiments thereof, it will be understood that it is not intended to limit the invention to those embodiments. On the contrary, it is intended to cover all alternatives, modifications, and equivalents as may be included within the spirit and scope of the invention as defined by the appended claims.

For a general understanding of the features of the present invention, reference is made to the drawings. In the drawings, like reference numerals have been used throughout to identify identical elements.

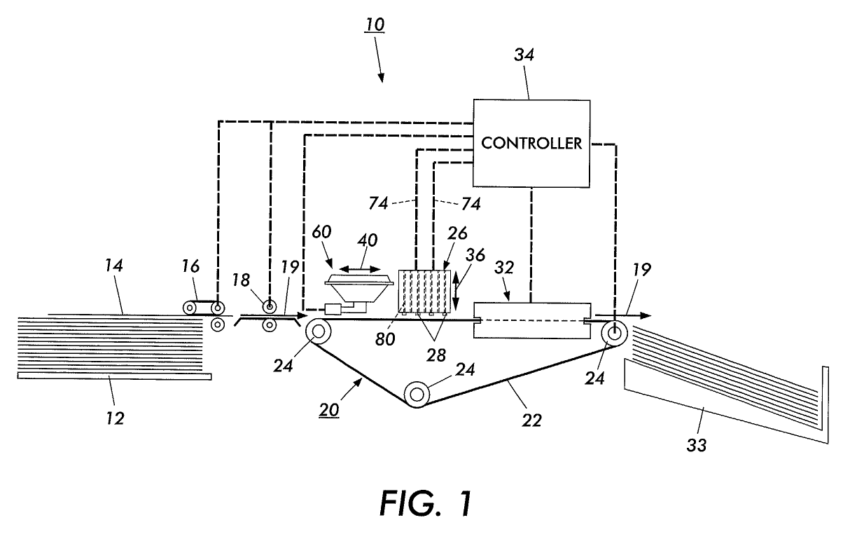

Referring now to FIG. 1, there is shown a schematic elevational view of a liquid ink printer 10, for instance, an ink jet printer. As shown, the liquid ink or ink jet printer 10 incorporates an input tray 12 containing sheets of a sheet of paper 14 to be printed upon by the printer 10. Single sheets of the sheet of paper 14 are removed from the input tray 12 by a pickup device 16 and fed by feed rollers 18 to a transport mechanism 20. The transport mechanism 20 moves the sheet by a feed belt or belts 22 driven by one of support rollers 24 beneath a liquid ink printhead assembly 26. The printhead assembly 26 as is well known, includes an ink supply (not labeled) attached for example to the printhead support or coupled to associated printheads through appropriate supply tubing.

The printhead assembly 26 includes printheads 28 which, for example, can be reciprocating printheads, or partial, or page width array, printheads supported in a printing position by a printhead support (not shown) in a confronting relation with the belt 22.

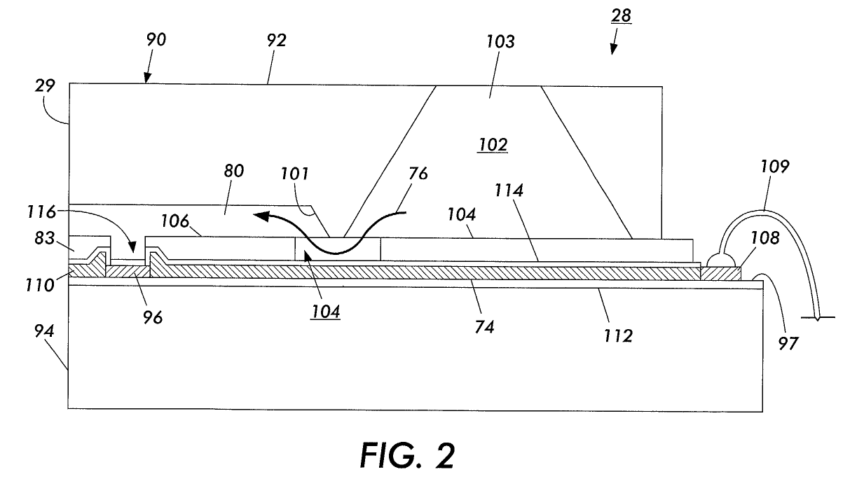

Referring now to FIG. 2, each printhead 28 comprises a printhead die 90 that is made up of a channel plate 92 and a heater or heating element plate 94. The heating element plate 94 has the heating elements 96 and addressing electrodes 74 patterned on the surface 97 thereof (with integral driver circuitry not shown), while the channel plate 92 has parallel grooves or channels 80 which extend in one direction and penetrate through the front face or nozzle face 29. The other end of the grooves terminate at a slanted wall 101 which is adjacent recess 102 that is etched through the channel plate and is used as the ink supply reservoir for the capillary filled ink channels 80. The open bottom 103 of the reservoir recess serves as an ink fill hole.

The surface of the channel plate with the grooves or channels 80 are aligned and bonded to the heater plate 94, so that a respective one of the plurality of heating elements 96 is positioned in each channel 80 formed by the grooves and the heater plate. Ink enters the reservoir formed by the recess 102 and the heater plate 94 through the fill hole 103, and by capillary action fills the channels 80 by flowing through either an elongated recess or bypass pit 104 formed in a thick film insulative layer 106 sandwiched between the heating element plate 94 and the channel plate 92. The ink (not shown) at each nozzle 83 forms a meniscus, the surface tension of which, together with a slightly negative ink pressure, prevents the ink from weeping from the nozzles. The addressing electrodes 74 and circuitry (not shown) on the heater plate 94 have terminals 108 for the attachment of wire bonds 109 that connect to the printer circuit boards (not shown). The plurality of sets of heating elements 96, their addressing electrodes 74, driver circuitry (not shown), and common return 110 are patterned on an underglaze layer 112, such as silicon dioxide.

After the fabricating of the heating elements 96, addressing electrodes 74, driver circuitry, and common return 110, they are passivated by a typical passivation layer 114. The passivation layer is removed from the heating elements 96 and electrode terminals 108, and a thick film layer 106 is deposited and patterned to provide the bypass trench or pits 104, and to place the heaters in pits 116.

Thus the channel plate 92 and heater plate 94 together define a plurality of ink grooves or channels 80 that each terminate in a printhead nozzle 83 on the nozzle face 29 of each the printhead 28. Within the printhead as such, ink is contained in the plurality of channels 80. When the printhead 28 is activated and placed in a print mode, energy pulses are applied via the addressing electrodes 74 to the heating elements (resistors) 96 for causing ink within the channels 80 to be expelled as droplets, as required, from the nozzles or orifices 83 at the ends of the channels.

Specifically, each such heating element or resistor 96 is individually addressable by the machine controller 34 selectively using electric current pulses. The resistors 96 serve to heat the ink in the channel 80, reducing its viscosity, and tending to vaporize it into a vapor bubble. As the vapor bubble grows in the selected channel being heated, ink bulges from the channel orifice or nozzle 83 until the electric current pulse has ceased and the bubble begins to collapse. At that stage, the ink within the channel retracts and separates from the bulging ink which forms a droplet moving in a direction away from the channel and towards a direction of ink droplet ejection. Thereafter, the channel is refilled by capillary action, drawing ink from a supply container into the channel.

During printing, the printheads 28 image-wise selectively or addressably eject and deposit droplets of liquid ink onto the sheet of paper 14 as the sheet is carried by the belt 22 past and beneath the nozzles of the plurality of printheads 28. As is well known, each of the printheads 28 includes an array of print nozzles, for instance, staggered or linear arrays, having a length sufficient to image-wise deposit droplets of ink as above, within a printing zone that lies below the printheads and is crossed the sheet of paper 14. As the sheet of paper 14 is moved through the printing zone, the printheads 28 print or record a liquid ink image on the sheet of paper 14.

After printing or recording of the liquid ink image as above within the printing zone, the sheet of paper 14 is then carried by the belt 22 through a dryer assembly 32 for drying the liquid ink image thereon. From the dryer assembly 32, the sheet of paper 14, with a dried ink image thereon may be moved to an output tray 33.

As shown, a controller 34 controls the operation of various aspects of the printer 10, including the transport mechanism 20, the dryer assembly 32 and the maintenance operation including the air bubble removal method in accordance with the present invention. The transport mechanism 20 for example includes the pickup device 16, the feed roller 18, the belt 22 and the drive rollers 24. In addition, the controller 34 controls the movement of the printhead assembly 26, printing by the printheads 28 as would be understood by one skilled in the art.

The controller 34 is preferably a self-contained, dedicated minicomputer having a central processor unit (CPU), electronic storage, and a display or user interface (Ul). With the help of sensors and connections (not shown), the controller 34 reads, captures, prepares and manages the flow of data for the image being printed by the printheads 28. In addition, the controller 34 is the main multi-tasking processor for operating and controlling all of the other machine subsystems and printing operations.

At the completion of a printing job or when otherwise necessary, such as during a power failure, the printhead assembly 26, is moved away from the belt 22 in the directions of an arrow 36. A vacuum assembly 60 including a molded capping member 52 is moved beneath the printhead assembly 26, in the directions of the arrow 40 for capping the printheads 28 of the printhead assembly 26. Once the capping member 52 is positioned directly beneath the printhead assembly 26, the printhead assembly 26 is moved towards the belt 22 and into sealing engagement with a raised membrane 50 on the molded capping member 52 for effective priming by application of the simultaneous push-pull method of the present invention (to be described in detail below).

When the printhead assembly 26, has been capped, and fully primed as above, and is again needed for another printing job, it is moved away from the belt 22 and the vacuum assembly 60 is then moved away from the printhead assembly 26 such that the printhead assembly 26 can be repositioned appropriately with respect to the belt 22 for printing on the recording sheets 14.

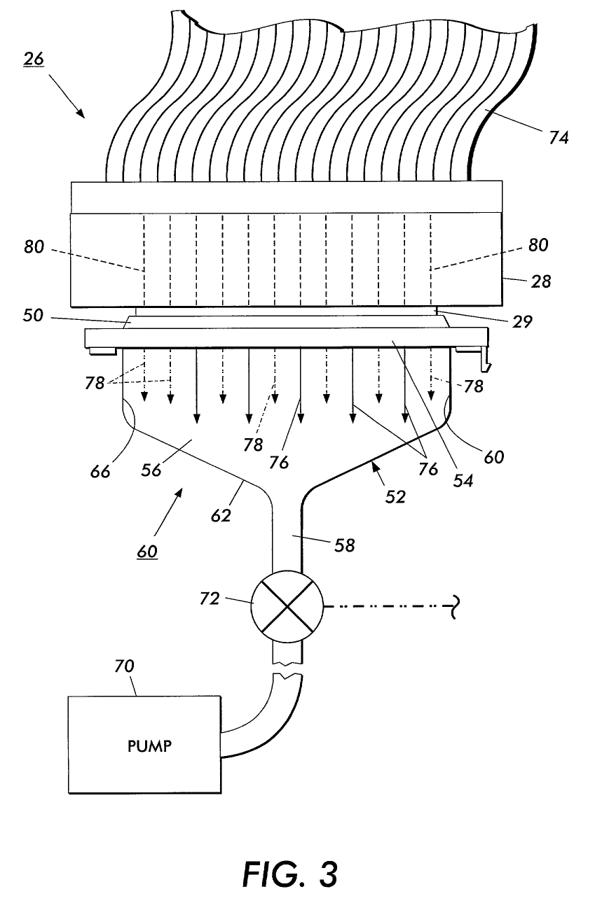

Referring to FIGS. 1-3 and in particular to FIGS. 2 and 3, the printhead assembly 26 includes for example, a reciprocating printhead 28, that has been moved into a capping position against the capping member 52 of the vacuum assembly 60. As shown, the raised membrane 50, preferably a low (20-30 shore “A”) durometer silicone rubber joined to the molded capping member 52 seals against a nozzle face 29 of each printhead 28. As further shown, the capping member 52 includes a substrate 54 and a capping chamber or recess 56 that terminates at a base 62 having an orifice into a vacuuming path 58 therethrough.

As further shown, the molded capping member 52 includes the bottom wall 62, and side walls 64, 66 defining the capping chamber or recess 56, as well as, the vacuuming path 58 from the vacuum device 70 into the capping chamber or recess 56.

The simultaneous push-pull method of removing air bubbles in accordance with the present invention is suitable for removing air bubbles from a powerable ink jet printhead comprising a printhead die 90 containing liquid ink and heating elements 96 within ink channels 80, and having a nozzle face 29 and nozzles 83 connected to the ink channels 80. The simultaneous push-pull method includes providing a printhead capping member 52 including side walls 64, 66, a bottom wall 62, a vacuuming path 58 through the bottom wall, and a capping recess 56 defined by the side walls and the bottom wall 62.

The method then includes applying heat energy to the heating elements 96 to reduce a viscosity of ink in the channels 80; activating a print mode of the printhead; firing the printhead 28 while in the print mode to eject droplets of liquid ink in an ink ejecting direction through nozzles 83 into the capping recess 56; and simultaneously applying a vacuum force through the capping recess 56 to the nozzle face 29 for additively pulling and moving ink in the ink channels through the nozzles 83 and in the ink ejecting direction 76, thereby effectively priming the nozzles 83 by reducing viscosity of ink in the channels and removing such ink and undesirable air bubbles from the ink channels.

Applying power or heat energy to the heating elements 96 is achieved through the controller 34 and power connector 74. As discussed above, application of heat energy as such reduces the viscosity of the ink in the channels 80, and the controller 34 activates and controls the firing of the nozzles. In accordance with an aspect of the present invention, the nozzles are controlled and fired as such sequentially, that is one after the other to ensure and monitor which nozzles are in deed unclogged and have fired, and which have not. The firing and simultaneous vacuum drawing can thus be repeated. The powering and firing of the powerable ink jet printhead as such thus forcibly pushes and ejects droplets of liquid ink, in an ink ejecting direction 76, through nozzles 83 in the nozzle face 29 and into the capping recess 56. The method then includes the step of simultaneously applying a vacuum force from the vacuum device 70 through the capping recess 56 to the nozzle face 29 for additively pulling and moving ink in the ink channels 80 through the nozzles and in a vacuum pull direction 78 that is the same as the ink ejecting direction 76. This thereby effectively primes the nozzles in the nozzle face 29 by removing ink and undesirable air bubbles from the ink channels 80.

The step of applying heat energy and power to the powerable printhead preferably includes sequentially firing the nozzles in the nozzle face one at a time or a group at a time. The valve 72 to the vacuuming path 58 is maintained in an open position while power is being applied to the printhead to fire the nozzles, and a vacuum force is being simultaneously applied in a push-pull manner to additively remove bubbles from the printhead.

As shown, the vacuum applying device or pump 70 is connected to the vacuuming path 58, through the valve 72, for applying a vacuum suction force to nozzles in the nozzle face 29. Power, preferably full power is applied through a power and controller connector 74. The power and controller connector 74 is connected to the printhead 28 and to its controller and drivers 34, for controllably and forcibly firing and ejecting drops of ink from the ink channels 80 through nozzles in the nozzle face 29. The full power ejection of ink drops through the nozzles when simultaneously combined with the vacuum suction force, effectively function to push-pull and suck out ink and bubbles from within the channels, thereby effectively priming the nozzles in the nozzle face 29.

The simultaneous push-pull method of removing bubbles from the powerable (powerable meaning simply that the printhead can be powered up and heated to fire or eject drops of ink) printhead 28 thus includes providing a printhead capping member 52 including a bottom wall 62 and side walls 64, 66 defining a capping recess 56 defined by the bottom wall, the side walls, and the nozzle face 29. The method also includes applying power to the powerable ink jet printhead 28 for forcibly pushing and ejecting drops of liquid ink in an ink ejecting direction 76 through nozzles in the nozzle face 29, and into the capping recess 56. Importantly, the method then includes simultaneously applying a vacuum force from the device 70 through the capping recess 56 to the nozzle face 29 for additively pulling and moving ink in the ink channels 80 through the nozzles and in the ink ejecting direction 76. This thereby effectively primes the nozzles in the nozzle face 29 by removing ink and undesirable air bubbles from the ink channels.

It is recalled that ordinarily, removing bubbles from the ink path of a printhead can be very difficult and requires the removal of large amounts of ink in order to “pull” the bubble out. The problem is that bubbles are difficult to break up and pull through the small nozzles of the printhead. The simultaneous push-pull method of the present invention effectively removes bubbles from even deep within ink channels connected to the nozzles in the nozzle face. The result is a bubble free ink path.

To recap, the present invention utilizes printing or full power ink drop ejection in conjunction with vacuum force pulling or priming to effectively remove offending air bubbles from the printhead. The printing or full power drop ejection operates to distort the air bubbles sufficiently such that the simultaneous application of vacuum can easily remove even large bubbles.

As can be seen, there has been provided a simultaneous push-pull method of, and apparatus for, removing air bubbles from a powerable ink jet printhead are provided. The printhead includes a printhead die containing liquid ink and heating elements within ink channels, and has a nozzle face and nozzles connected to the ink channels. The simultaneous push-pull method includes providing a printhead capping member including side walls, a bottom wall, a vacuuming path through the bottom wall, and a capping recess defined by the side walls and the bottom wall. The method then includes applying heat energy to the heating elements to reduce a viscosity of ink in the channels, activating a print mode of the printhead, firing the printhead while in the print mode to eject droplets of liquid ink in an ink ejecting direction through nozzles into the capping recess. The method also includes simultaneously applying a vacuum force through the capping recess to the nozzle face for additively pulling and moving ink in the ink channels through the nozzles and in the ink ejecting direction, thereby effectively priming the nozzles by reducing viscosity of ink in the channels and removing such ink and undesirable air bubbles from the ink channels.

While the embodiment disclosed herein is preferred, it will be appreciated from this teaching that various alternative, modifications, variations or improvements therein may be made by those skilled in the art, which are intended to be encompassed by the following claims:

1. A simultaneous push-pull method of removing air bubbles from a powerable ink jet printhead including a printhead die containing liquid ink within ink channels and having a nozzle face and nozzles connected to the ink channels, the simultaneous push-pull method comprising:
(a) providing a printhead capping member including side walls, a bottom wall, a vacuuming path through the bottom wall, and a capping recess defined by the side walls and the bottom wall;
(b) applying heat energy to the printhead die to reduce a viscosity of in the channels of the printhead;
(c) activating a print mode of the printhead;
(d) firing the printhead nozzles while in the print mode to eject droplets of liquid ink in an ink ejecting direction through nozzles in the nozzle face and into the capping recess; and
(e) simultaneously applying a vacuum force through the capping recess to the nozzle face of the printhead for additively pulling and moving ink in the ink channels through the nozzles and in the ink ejecting direction, thereby effectively priming the nozzles in the nozzle face by reducing viscosity of ink in the channels and removing such ink and undesirable air bubbles from the ink channels.

2. The simultaneous push-pull method of claim 1, wherein the step of firing the printhead nozzles comprises sequentially firing such nozzles.

3. The simultaneous push-pull method of claim 1, wherein the step of simultaneously applying a vacuum force includes maintaining a valve in the vacuum applying path in an open position.

4. An ink jet printer including apparatus for effectively removing air bubbles from a powerable printhead, the ink jet printer comprising:
(a) a frame including means for feeding and transporting a recording medium;
(b) a powerable ink jet printhead comprising a printhead die having ink channels for containing liquid ink, channel heating elements for heating ink in said channels to reduce viscosity of such ink, and a nozzle face including nozzles connected to said ink channels;
(c) a printhead capping member including side walls, a bottom wall, a vacuuming path through said bottom wall, and a capping recess defined by said side walls and said bottom wall;
(d) means for applying heat energy to said channel heating elements of said printhead die to reduce a viscosity of ink in said ink channels;
(e) vacuum means for applying a vacuum force through said capping recess to said nozzle face of said printhead for pulling and moving ink in said ink channels through said nozzles and in an ink ejecting direction; and
(f) a programmed controller for activating and enabling simultaneously firing of said nozzles, while said vacuum means is applying said vacuum force, to eject droplets of liquid ink in the ink ejecting direction through said nozzles, thereby effectively priming said nozzles in said nozzle face by reducing viscosity of ink in said ink channels and removing such ink and undesirable air bubbles from said ink channels.

5. The ink jet printer of claim 4, wherein said channel heating elements comprise resistors.

6. The ink jet printer of claim 4, wherein said means for applying heat energy to said channel heating elements comprises an electrical addressing electrodes.

7. The ink jet printer of claim 4, wherein said means for applying heat energy to said channel heating elements comprises electrical pulses.
